(19) United States
(12) Patent Application Publication
(10) Pub. No.: US 2015/0114843 A1
(43) Pub. Date: Apr. 30, 2015

(54) ELECTROCATALYTIC HYDROGEN PRODUCTION PROMOTED BY VISIBLE LIGHT

(71) Applicant: The University of North Carolina at Chapel Hill, Chapel Hill, NC (US)

(72) Inventors: Catherine L. Pitman, Chapel Hill, NC (US); Alexander J. Miller, Chapel Hill, NC (US)

(21) Appl. No.: 14/520,930

(22) Filed: Oct. 22, 2014

Related U.S. Application Data
(60) Provisional application No. 61/895,657, filed on Oct. 25, 2013.

(51) Int. Cl. C01B 3/04; C25B 1/00; C25B 1/10; B01J 19/12; C25B 1/04

(52) U.S. Cl. CPC C01B 3/042; B01J 19/12; C25B 1/04; C25B 1/10; C25B 1/003; C01B 2203/1064; C01B 2203/0277
USPC 205/340; 204/280; 204/252; 204/266

(57) ABSTRACT

A method for the photoelectrocatalytic production of hydrogen and oxygen from water, is carried out by: (a) providing a photohydride proton reduction catalyst and a photoanode having water oxidation catalyst operatively associated therewith, both in an aquous electrolyte solution,wherein the photohydride proton reduction catalyst comprises a single-component light absorbing catalytic metal complex of the formula AXB, wherein A is a coordinated aromatic group, X is a metal, and B is a bidentate organic ligand; and (b) illuminating the photoanode and the photohydride proton reduction catalyst with visible light to generate O₂ by the action of the water oxidation catalyst and H₂ by the action of the photohydride proton reduction catalyst. Constructs and apparatus useful for carrying out the method are also described.

### RELATED APPLICATIONS

This application claims the benefit of U.S. Provisional Patent Application Ser. No. 61/895,657, filed Oct. 25, 2013, the disclosure of which is incorporated by reference herein in its entirety.

### FIELD OF THE INVENTION

The present invention concerns methods, cathode constructs, and apparatus useful for the catalytic production of hydrogen from water.

### BACKGROUND OF THE INVENTION

Hydrogen, generated from water using the energy of the sun, is widely recognized as a promising solar fuel. Complex photoelectrocatalyst (PEC) systems have been developed that harness the energy of incident sunlight to split water into oxygen and hydrogen. In general, PECs are composed of multiple components, including light absorbers, oxidation catalysts, and reduction catalysts.

Focusing on the fuel-producing side of a PEC cell, a common strategy employs a small band gap semiconductor photoanode coupled with a homogeneous or heterogeneous catalyst. A typical scheme for photoelectrocatalytic H₂ evolution is shown in FIG. 1A. A semiconductor at a constant applied potential absorbs visible light, generating an exciton. The high-energy conduction band electron has a formal potential much more negative than the applied potential. Injection of the electron into the catalyst leads to a reduced state and initiates a catalytic cycle at applied potentials where no catalysis would occur in the dark. A major impact of this scheme is a reduction in electrochemical overpotential: only a modestly negative applied potential is required to achieve the reactivity normally associated with very negative applied potentials in the dark. In general, the catalyst component does not absorb light productively; weakly absorbing catalysts are sought in order to maximize semiconductor absorption.

While significant strides have been made towards efficient PECs, two-component photoanode-catalyst assemblies are challenging to design and optimize: a limited selection of semiconductor photoanode materials are known; both the photoanode and the catalyst often suffer from corrosion or other degradation pathways in the aqueous environment; and characterizing and tuning the semiconductor such that the band gap matches the catalyst redox properties is difficult. ^{1,2,3,4,5,6,7}

### SUMMARY OF THE INVENTION

An alternative to two-component semiconductor PECs is proposed in FIG. 1B. Rather than rely on excited state electron transfer from a photosensitizer (usually a semiconductor electrode), the process would rely on photocatalytic hydrogen evolution, wherein the hydrogen release was light triggered. This is an attractive scheme because it removes the burden of semiconductor design, allowing for highly tunable reactivity through molecular design. The impact is the same: hydrogen fuel production at applied potential close to the H⁺/H₂ thermodynamic potential, with dramatically lowered overpotential to achieve good activity. Only a handful of light-driven hydrogen evolution catalysts are known, however, and this concept has not yet been realized.

Accordingly, the present invention provides, among other things, a method for the photoelectrocatalytic production of hydrogen and oxygen from water, comprising:

(a) providing a photohydride proton reduction catalyst and a photoanode having a water oxidation catalyst operatively associated therewith, both in an aquous electrolyte solution,

wherein said photohydride proton reduction catalyst comprises a single-component light absorbing catalytic metal complex of the formula AXB, wherein A is a coordinated aromatic group, X is a metal, and B is an organic ligand; and

(b) illuminating said photoanode and said photohydride proton reduction catalyst with light to generate O₂ by the action of said water oxidation catalyst and H₂ by the action of said photohydride proton reduction catalyst.

A further aspect of the invention is an apparatus for the photoelectrocatalytic evolution of hydrogen and oxygen from water, comprising:

(a) a reactor vessel having (i) an oxygen generation chamber, (ii) a hydrogen generation chamber,

(b) a photohydride proton reduction catalyst operatively associated with said hydrogen generation chamber; wherein said photohydride proton reduction catalyst comprises a single-component light absorbing catalytic metal complex of the Formula AXB, wherein A is a coordinated aromatic group; X is a metal, and B is an organic ligand;

(c) a photoanode in fluid communication with said oxygen generation chamber, said photoanode having a water oxidation catalyst operatively associated therewith;

(d) a light source operatively associated with said photohydride proton reduction catalyst and said photoanode.

In some embodiments, the cathode and the anode are electrically connected by both an external circuit (e.g. a conductor such as a wire) and the electrolyte solution.

In some embodiments, both the water oxidation catalyst and said photohydride proton reduction catalyst are operatively associated with a semiconductor substrate.

In some embodiments, the apparatus further comprises an ion-permeable membrane separating said oxygen generation chamber and said hydrogen generation chamber.

In some embodiments, there is a cathode in fluid communication with said hydrogen generation chamber, wherein the photohydride proton reduction catalyst operatively associated with said cathode.

The foregoing and other objects and aspects of the invention are explained in greater detail in the drawings herein and the specification set forth below. The disclosures of all United States Patent references cited herein are to be incorporated by reference herein as if fully set forth.

### BRIEF DESCRIPTION OF THE DRAWINGS

FIG. 1. Schematic representations of: (A) typical two-component semiconductor photoelectrocatalysis; and (B) single-component molecular photoelectrocatalysis (this work).

FIG. 2. Schematic illustration of an embodiment of the invention.

FIG. 3A. Sustained photoelectrocatalysis at −1 V of 1 mM [Cp*Ir(bpy)Cl]+in 100 mM pH=7 phosphate buffer (grey). Dark current (black)

FIG. 3B. Controlled potential electrolysis at −0.9 V of 1 mM [Cp*Ir(bpy)Cl]+in 100 mM pH=7 phosphate buffer with light off (white) and on (grey).

FIG. 4. Chronoamperometric traces of 1 mM 1 in pH 7 phosphate buffer in the dark (black) and under 460 nm LED irradiation (blue) at −0.9 V. The inset plots the ratio of the two traces (blue), with a fit data according to the method of Stiehl shown in red.The only variable in the fit is the catalytic rate constant, k_{cat}=0.034 s⁻¹.

### DETAILED DESCRIPTION OF THE PREFERRED EMBODIMENTS

1. Definitions.

“Electron-withdrawing” and “electron donating” refer to the ability of a substituent to withdraw or donate electrons relative to that of hydrogen if the hydrogen atom occupied the same position in the molecule. These terms are well understood by one skilled in the art and are discussed in Advanced Organic Chemistry, by J. March, John Wiley and Sons, New York, N.Y., pp. 16-18 (1985), incorporated herein by reference. Examples of such electron withdrawing and electron donating groups or substituents include, but are not limited to halo, nitro, cyano, carboxy, alkylcarboxy, loweralkenyl, loweralkynyl, loweralkanoyl (e.g., formyl), carboxyamido, aryl, quaternary ammonium, aryl (loweralkanoyl), carbalkoxy and the like; acyl, carboxy, alkanoyloxy, aryloxy, alkoxysulfonyl, aryloxysulfonyl, and the like; hydroxy, alkoxy or loweralkoxy (including methoxy, ethoxy and the like); loweralkyl; amino, alkylamino, lower alkylamino, di(loweralkyl) amino, aryloxy (such as phenoxy), mercapto, loweralkylthio, lower alkylmercapto, disulfide (loweralkyldithio) and the like; 1-piperidino, 1-piperazino, 1-pyrrolidino, acylamino, hydroxyl, thiolo, alkylthio, arylthio, aryloxy, alkyl, ester groups (e.g., alkylcarboxy, arylcarboxy, heterocyclocarboxy), azido, isothiocyanato, isocyanato, thiocyanato, cyanato, and the like. One skilled in the art will appreciate that the aforesaid substituents may have electron donating or electron withdrawing properties under different chemical conditions. Moreover, the present invention contemplates any combination of substituents selected from the above-identified groups. See U.S. Pat. Nos. 6,133,261 and 5,654,301; see also U.S. Pat. No. 4,711,532.

“Halo” as used herein refers to any suitable halogen, including —F, —Cl, —Br, and —I.

“Mercapto” as used herein refers to an —SH group.

“Azido” as used herein refers to an —N₃ group.

“Cyano” as used herein refers to a —CN group.

“Hydroxyl” as used herein refers to an —OH group.

“Nitro” as used herein refers to an —NO₂ group.

“Alkyl” as used herein alone or as part of another group, refers to a straight or branched chain hydrocarbon containing from 1 to 10 carbon atoms. Representative examples of alkyl include, but are not limited to, methyl, ethyl, n-propyl, iso-propyl, n-butyl, sec-butyl, iso-butyl, tert-butyl, n-pentyl, isopentyl, neopentyl, n-hexyl, 3-methylhexyl, 2,2-dimethylpentyl, 2,3-dimethylpentyl, n-heptyl, n-octyl, n-nonyl, n-decyl, and the like. “Lower alkyl” as used herein, is a subset of alkyl, in some embodiments preferred, and refers to a straight or branched chain hydrocarbon group containing from 1 to 4 carbon atoms. Representative examples of lower alkyl include, but are not limited to, methyl, ethyl, n-propyl, iso-propyl, n-butyl, iso-butyl, tert-butyl, and the like. The term “akyl” or “loweralkyl” is intended to include both substituted and unsubstituted alkyl or loweralkyl unless otherwise indicated and these groups may be substituted with groups selected from halo, alkyl, haloalkyl, alkenyl, alkynyl, cycloalkyl, cycloalkylalkyl, aryl, arylalkyl, heterocyclo, heterocycloalkyl, hydroxyl, alkoxy (thereby creating a polyalkoxy such as polyethylene glycol), alkenyloxy, alkynyloxy, haloalkoxy, cycloalkoxy, cycloalkylalkyloxy, aryloxy, arylalkyloxy, heterocyclooxy, heterocyclolalkyloxy, mercapto, alkyl-S(O)ₘ, haloalkyl-S(O)ₘ, alkenyl-S(O)ₘ, alkynyl-S(O)ₘ, cycloalkyl-S(O)ₘ, cycloalkylalkyl-S(O)ₘ, aryl-S(O)ₘ, arylalkyl-S(O)ₘ, heterocyclo-S(O)ₘ, heterocycloalkyl-S(O)ₘ, amino, carboxy, alkylamino, alkenylamino, alkynylamino, haloalkylamino, cycloalkylamino, cycloalkylalkylamino, arylamino, arylalkylamino, heterocyclo amino, heterocycloalkylamino, disubstituted-amino, acylamino, acyloxy, ester, amide, sulfonamide, urea, alkoxyacylamino, aminoacyloxy, nitro or cyano where m=0, 1, 2 or 3.

“Alkenyl” as used herein alone or as part of another group, refers to a straight or branched chain hydrocarbon containing from 1 to 10 carbon atoms (or in loweralkenyl 1 to 4 carbon atoms) which include 1 to 4 double bonds in the normal chain. Representative examples of alkenyl include, but are not limited to, vinyl, 2-propenyl, 3-butenyl, 2-butenyl, 4-pentenyl, 3-pentenyl, 2-hexenyl, 3-hexenyl, 2,4-heptadiene, and the like. The term “alkenyl” or “loweralkenyl” is intended to include both substituted and unsubstituted alkenyl or loweralkenyl unless otherwise indicated and these groups may be substituted with groups as described in connection with alkyl and loweralkyl above.

“Alkynyl” as used herein alone or as part of another group, refers to a straight or branched chain hydrocarbon containing from 1 to 10 carbon atoms (or in loweralkynyl 1 to 4 carbon atoms) which include 1 triple bond in the normal chain. Representative examples of alkynyl include, but are not limited to, 2-propynyl, 3-butynyl, 2- butynyl, 4-pentynyl, 3-pentynyl, and the like. The term “alkynyl” or “loweralkynyl” is intended to include both substituted and unsubstituted alkynyl or loweralknynyl unless otherwise indicated and these groups may be substituted with the same groups as set forth in connection with alkyl and loweralkyl above.

“Alkoxy” as used herein alone or as part of another group, refers to an alkyl or loweralkyl group, as defined herein (and thus including substituted versions such as polyalkoxy), appended to the parent molecular moiety through an oxy group, —O—. Representative examples of alkoxy include, but are not limited to, methoxy, ethoxy, propoxy, 2-propoxy, butoxy, tert-butoxy, pentyloxy, hexyloxy and the like.

“Acyl” as used herein alone or as part of another group refers to a —C(O)R radical, where R is any suitable substituent such as aryl, alkyl, alkenyl, alkynyl, cycloalkyl or other suitable substituent as described herein.

“Haloalkyl” as used herein alone or as part of another group, refers to at least one halogen, as defined herein, appended to the parent molecular moiety through an alkyl group, as defined herein. Representative examples of haloalkyl include, but are not limited to, chloromethyl, 2-fluoroethyl, trifluoromethyl, pentafluoroethyl, 2-chloro-3-fluoropentyl, and the like.

“Alkylthio” as used herein alone or as part of another group, refers to an alkyl group, as defined herein, appended to the parent molecular moiety through a thio moiety, as defined herein. Representative examples of alkylthio include, but are not limited, methylthio, ethylthio, tert-butylthio, hexylthio, and the like.

“Aryl” as used herein alone or as part of another group, refers to a monocyclic carbocyclic ring system or a bicyclic carbocyclic fused ring system having one or more aromatic rings. Representative examples of aryl include, azulenyl, indanyl, indenyl, naphthyl, phenyl, tetrahydronaphthyl, and the like. The term “aryl” is intended to include both substituted and unsubstituted aryl unless otherwise indicated and these groups may be substituted with the same groups as set forth in connection with alkyl and loweralkyl above.

“Arylalkyl” as used herein alone or as part of another group, refers to an aryl group, as defined herein, appended to the parent molecular moiety through an alkyl group, as defined herein. Representative examples of arylalkyl include, but are not limited to, benzyl, 2-phenylethyl, 3-phenylpropyl, 2-naphth-2-ylethyl, and the like.

“Amino” as used herein means the radical —NH₂.

“Alkylamino” as used herein alone or as part of another group means the radical —NHR, where R is an alkyl group.

“Arylalkylamino” as used herein alone or as part of another group means the radical —NHR, where R is an arylalkyl group.

“Disubstituted-amino” as used herein alone or as part of another group means the radical —NRₐR_{b}, where Rₐ and R_{b} are independently selected from the groups alkyl, haloalkyl, alkenyl, alkynyl, cycloalkyl, cycloalkylalkyl, aryl, arylalkyl, heterocyclo, heterocycloalkyl.

“Acylamino” as used herein alone or as part of another group means the radical —NRₐR_{b}, where Rₐ is an acyl group as defined herein and R_{b} is selected from the groups hydrogen, alkyl, haloalkyl, alkenyl, alkynyl, cycloalkyl, cycloalkylalkyl, aryl, arylalkyl, heterocyclo, heterocycloalkyl.

“Acyloxy” as used herein alone or as part of another group means the radical —OR, where R is an acyl group as defined herein.

“Ester” as used herein alone or as part of another group refers to a —C(O)OR radical, where R is any suitable substituent such as alkyl, cycloalkyl, alkenyl, alkynyl or aryl.

“Formyl” as used herein refers to a —C(O)H group.

“Carboxylic acid” as used herein refers to a —C(O)OH group.

“Sulfoxyl” as used herein refers to a compound of the formula —S(O)R, where R is any suitable substituent such as alkyl, cycloalkyl, alkenyl, alkynyl or aryl.

“Sulfonyl as used herein refers to a compound of the formula —S(O)(O)R, where R is any suitable substituent such as alkyl, cycloalkyl, alkenyl, alkynyl or aryl.

“Sulfonate” as used herein refers to a compounnd of the formula —S(O)(O)OR, where R is any suitable substituent such as alkyl, cycloalkyl, alkenyl, alkynyl or aryl.

“Sulfonic acid as used herein refers to a compound of the formula —S(O)(O)OH.

“Amide” as used herein alone or as part of another group refers to a —C(O)NRₐR_{b} radical, where Rₐ and R_{b} are any suitable substituent such as alkyl, cycloalkyl, alkenyl, alkynyl or aryl.

“Sulfonamide” as used herein alone or as part of another group refers to a —S(O)₂NRₐR_{b} radical, where Rₐ and R_{b} are any suitable substituent such as H, alkyl, cycloalkyl, alkenyl, alkynyl or aryl.

“Urea” as used herein alone or as part of another group refers to an —N(R_{c})C(O)NRₐR_{b} radical, where Rₐ, R_{b} and R_{c} are any suitable substituent such as H, alkyl, cycloalkyl, alkenyl, alkynyl or aryl.

“Alkoxyacylamino” as used herein alone or as part of another group refers to an —N(Rₐ)C(O)OR_{b} radical, where Rₐ, R_{b} are any suitable substituent such as H, alkyl, cycloalkyl, alkenyl, alkynyl or aryl.

“Aminoacyloxy” as used herein alone or as part of another group refers to an —OC(O)NRₐR_{b} radical, where Rₐ and R_{b} are any suitable substituent such as H, alkyl, cycloalkyl, alkenyl, alkynyl or aryl.

“Cycloalkyl” as used herein alone or as part of another group, refers to a saturated or partially unsaturated cyclic hydrocarbon group containing from 3, 4 or 5 to 6, 7 or 8 carbons (which carbons may be replaced in a heterocyclic group as discussed below). Representative examples of cycloalkyl include, cyclopropyl, cyclobutyl, cyclopentyl, cyclohexyl, cycloheptyl, and cyclooctyl. These rings may be optionally substituted with additional substituents as described herein such as halo or loweralkyl. The term “cycloalkyl” is generic and intended to include heterocyclic groups as discussed below unless specified otherwise.

“Heterocyclic group” or “heterocyclo” as used herein alone or as part of another group, refers to an aliphatic (e.g., fully or partially saturated heterocyclo) or aromatic (e.g., heteroaryl) monocyclic- or a bicyclic-ring system. Monocyclic ring systems are exemplified by any 5 or 6 membered ring containing 1, 2, 3, or 4 heteroatoms independently selected from oxygen, nitrogen and sulfur. The 5 membered ring has from 0-2 double bonds and the 6 membered ring has from 0-3 double bonds. Representative examples of monocyclic ring systems include, but are not limited to, azetidine, azepine, aziridine, diazepine, 1,3-dioxolane, dioxane, dithiane, furan, imidazole, imidazoline, imidazolidine, isothiazole, isothiazoline, isothiazolidine, isoxazole, isoxazoline, isoxazolidine, morpholine, oxadiazole, oxadiazoline, oxadiazolidine, oxazole, oxazoline, oxazolidine, piperazine, piperidine, pyran, pyrazine, pyrazole, pyrazoline, pyrazolidine, pyridine, pyrimidine, pyridazine, pyrrole, pyrroline, pyrrolidine, tetrahydrofuran, tetrahydrothiophene, tetrazine, tetrazole, thiadiazole, thiadiazoline, thiadiazolidine, thiazole, thiazoline, thiazolidine, thiophene, thiomorpholine, thiomorpholine sulfone, thiopyran, triazine, triazole, trithiane, and the like. Bicyclic ring systems are exemplified by any of the above monocyclic ring systems fused to an aryl group as defined herein, a cycloalkyl group as defined herein, or another monocyclic ring system as defined herein. Representative examples of bicyclic ring systems include but are not limited to, for example, benzimidazole, benzothiazole, benzothiadiazole, benzothiophene, benzoxadiazole, benzoxazole, benzofuran, benzopyran, benzothiopyran, benzodioxine, 1,3-benzodioxole, cinnoline, indazole, indole, indoline, indolizine, naphthyridine, isobenzofuran, isobenzothiophene, isoindole, isoindoline, isoquinoline, phthalazine, purine, pyranopyridine, quinoline, quinolizine, quinoxaline, quinazoline, tetrahydroisoquinoline, tetrahydroquinoline, thiopyranopyridine, and the like. These rings include quaternized derivatives thereof and may be optionally substituted with groups selected from halo, alkyl, haloalkyl, alkenyl, alkynyl, cycloalkyl, cycloalkylalkyl, aryl, arylalkyl, heterocyclo, heterocycloalkyl, hydroxyl, alkoxy, alkenyloxy, alkynyloxy, haloalkoxy, cycloalkoxy, cycloalkylalkyloxy, aryloxy, arylalkyloxy, heterocyclooxy, heterocyclolalkyloxy, mercapto, alkyl-S(O)ₘ, haloalkyl-S(O)ₘ, alkenyl-S(O)ₘ, alkynyl-S(O)ₘ, cycloalkyl-S(O)ₘ, cycloalkylalkyl-S(O)ₘ, aryl-S(O)ₘ, arylalkyl-S(O)ₘ, heterocyclo-S(O)ₘ, heterocycloalkyl-S(O)ₘ, amino, alkylamino, alkenylamino, alkynylamino, haloalkylamino, cycloalkylamino, cycloalkylalkylamino, arylamino, arylalkylamino, heterocycloamino, heterocycloalkylamino, disubstituted-amino, acylamino, acyloxy, ester, amide, sulfonamide, urea, alkoxyacylamino, aminoacyloxy, nitro or cyano where m=0, 1, 2 or 3. Preferred heterocyclo groups include pyridyl and imidazolyl groups, these terms including the the quaternized derivatives thereof, including but not limited to quaternary pyridyl and imidazolyl groups, examples of which include but are not limited to:

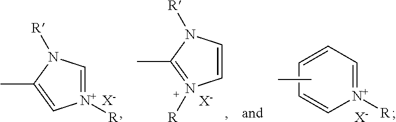

where R and R′ are each a suitable substitutent as described in connection with “alkyl” above, and particularly alkyl (such as methyl, ethyl or propyl), arylalkyl (such as benzyl), optionally substituted with hydroxy (—OH), phosphonic acid (—PO₃H₂) or sulfonic acid (—SO₃H), and X⁻ is a counterion.

“Silyl” as used herein refers to a group of the formula —SiR^{a}R^{b}R^{c}, wherein R^{a}, R^{b}, and R^{c} are any suitable independently selected hydrocarbyl group, including but not limited to alkyl, aryl, alkylaryl, etc. Examples include, but are not limited to, trimethyl silyl, tent-butyl dimethyl silyl, etc.

“Spiroalkyl” as used herein alone or as part of another group, refers to a straight or branched chain hydrocarbon, saturated or unsaturated, containing from 3 to 8 carbon atoms. Representative examples include, but are not limited to, —CH₂CH₂CH₂—, —CH₂CH₂CH₂CH₂—, —CH₂CH₂CH₂CH₂CH₂—, —CH₂CH₂CHCHCH₂—, —CH₂CH₂CH₂CH₂CH₂CH₂—, etc. The term “spiroalkyl” is intended to include both substituted and unsubstituted “spiroalkyl” unless otherwise indicated and these groups may be substituted with groups selected from halo, alkyl, haloalkyl, alkenyl, alkynyl, cycloalkyl, cycloalkylalkyl, aryl, arylalkyl, heterocyclo, heterocycloalkyl, hydroxyl, alkoxy, alkenyloxy, alkynyloxy, haloalkoxy, cycloalkoxy, cycloalkylalkyloxy, aryloxy, arylalkyloxy, heterocyclooxy, heterocyclolalkyloxy, mercapto, alkyl-S(O)ₘ, haloalkyl-S(O)ₘ, alkenyl-S(O)ₘ, alkynyl-S(O)ₘ, cycloalkyl-S(O)ₘ, cycloalkylalkyl-S(O)ₘ, aryl-S(O)ₘ, arylalkyl-S(O)ₘ, heterocyclo-S(O)ₘ, heterocycloalkyl-S(O)ₘ, amino, alkylamino, alkenylamino, alkynylamino, haloalkylamino, cycloalkylamino, cycloalkylalkylamino, arylamino, arylalkylamino, heterocycloamino, heterocycloalkylamino, disubstituted-amino, acylamino, acyloxy, ester, amide, sulfonamide, urea, alkoxyacylamino, aminoacyloxy, nitro or cyano where m=0, 1 or 2.

2. Proton Reduction Catalysts.

As noted above, the present invention utilizes and provides catalysts, or more particularly photohydride proton reduction catalysts. Such catalysts generally comprises a single-component light absorbing catalytic metal complex of the formula AXB, wherein:

A is a coordinated aromatic group,

X is a metal (e.g., iridium, rhodium, or cobalt); and

B is an organic ligand (e.g., an aliphatic, aromatic, or mixed aliphatic/aromatic group, including heteraromatic ligands and diimines).

Any suitable aromatic groups “A” may be used. In general, such groups are a 5 to 7 carbon aromatic ring or fused aromatic ring system, unsubstituted or optionally substituted from from 1 to 7 times with independently selected electron withdrawing groups, electron donating groups, surface attachment groups (or linking groups formed from the coupling of said surface attachment group to a substrate such as a semiconductor or cathode). Particular examples include, but are not limited to:

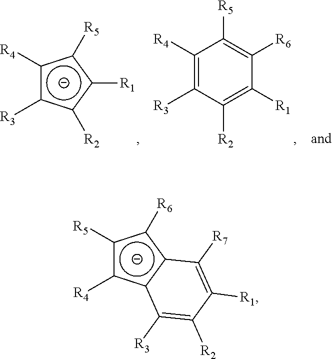

wherein each of R₁, R₂, R₃, R₄, R₅, R₆, and R₇ when present is independently selected from the group consisting of H, electron withdrawing groups, electron donating groups, surface attachment groups and linking groups formed from the coupling of said surface attachment group to said cathode.

Ligand “B” may be any suitable, generally bidentate, organic ligand, such as a diimine. Such compounds are either known or can be made by those skilled in the art in accordance with known techniques in view of the guidance herein. See, e.g., U.S. Pat. No. 7,550,246 to Fukuzumi et al; US Patent Application Pub. No. US 2013/0065864 to Habtemariam et al., and R. Ziessel., J. Am. Chem. Soc. 115, 118-127 (1993). In some embodiments, suitable groups “B” generally comprise a heteroaromatic group containing from 1 to 4 nitrogen atoms and 6 to 20 carbon atoms, which heteroaromatic group is optionally substituted from 1 to 10 or 20 times with independently selected electron withdrawing groups, electron donating groups, surface attachment groups, and linking groups formed from the coupling of said surface attachment groups to said cathode. Examples of suitable groups “B” include, but are not limited to:

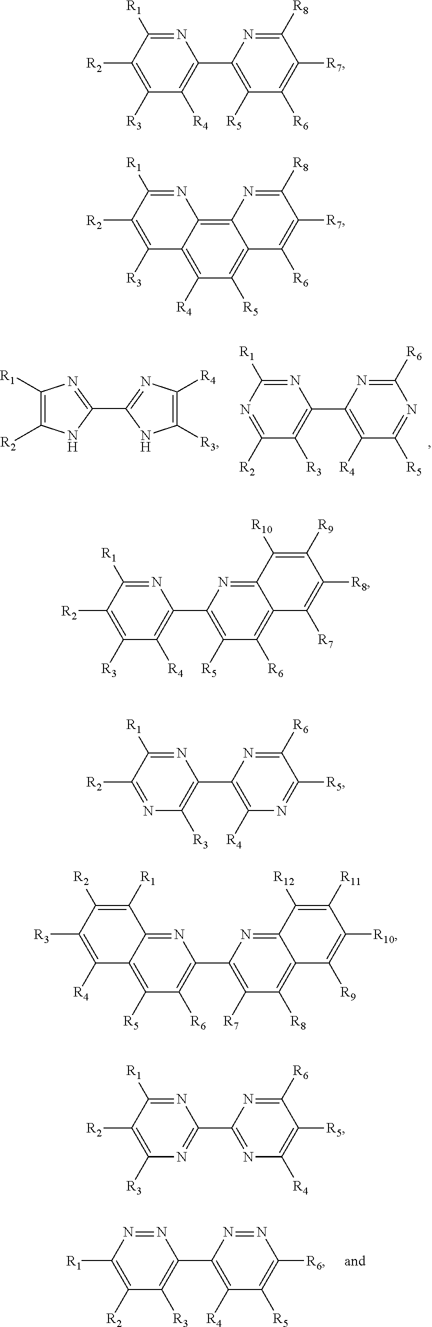

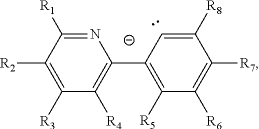

wherein each of R₁, R₂, R₃, R₄, R₅, R₆, R₇, R₈, R₉, R₁₀, R₁₁, and R₁₂ when present is independently selected from the group consisting of H, electron withdrawing groups, electron donating groups, surface attachment groups, and linking groups formed from the coupling of said surface attachment groups to said cathode. Note also that adjacent ones of R₁ and R₂, R₂ and R₃, R₃ and R₄, R₄ and R₅, R₅ and R₆, R₆ and R₇, R₇ and R₈, R₈ and R₉, R₉ and R₁₀, R₁₀ and R₁₁, and R₁₁ and R₁₂ can form a fused ring or a fused ring system, which fused ring or fused ring system can in turn be unsubstituted or substited with electron withdrawing groups, electron donating groups, surface attachment groups, and linking groups formed from the coupling of said surface attachment groups to the substrate or cathode.

Additional examples of suitable ligands “B” include, but are not limited to:

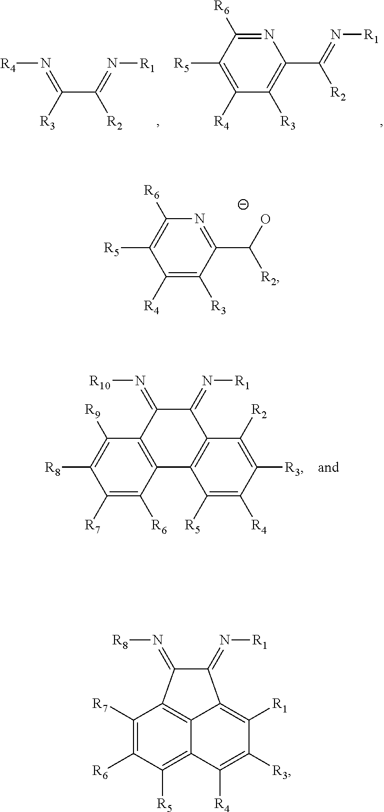

wherein each of R₁, R₂, R₃, R₄, R₅, R₆, R₇, R₈, R₉, and R₁₀ when present is independently selected from the group consisting of H, electron withdrawing groups, electron donating groups, surface attachment groups, and linking groups formed from the coupling of said surface attachment groups to said cathode. Again note also that adjacent ones of R₁ and R₂, R₂ and R₃, R₃ and R₄, R₄ and R₅, R₅ and R₆, R₆ and R₇, R₇ and R₈, R₈ and R₉, and R₉ and R₁₀ can form a fused ring or a fused ring system, which fused ring or fused ring system can in turn be unsubstituted or substited with electron withdrawing groups, electron donating groups, surface attachment groups, and linking groups formed from the coupling of said surface attachment groups to said cathode.

Surface attachment groups. As noted above, compounds of the invention can be substituted with one or more surface attachment groups (on either group A or group B, preferably on group B), which may be in protected or unprotected form. Numerous surface attachment groups are known and the specific choice will depend on the substrate to which the catalyst is being operatively associated or coupled (e.g., covalently or noncovalently coupled) and the particular coupling technique employed.

In general, a surface attachment group may be a reactive group coupled directly to the aromatic or heteroaromatic group by an intervening internal linker. Such linkers can be aryl, alkyl, heteroaryl, heteroalkyl (e.g., oligoethylene glycol), peptide, polysaccharide, etc. Examples of surface attachment groups (with the reactive site or group in unprotected form) include but are not limited to alkene, alkyne, alcohol, thiol, selenyl, phosphono, telluryl, cyano, amino, formyl, halo, boryl, and carboxylic acid, azide, and silyl surface attachment groups. Numerous such groups are known and are described in, for example Balakumar, Muthukumaran and Lindsey, U.S. patent application Ser. No. 10/867,512 (filed Jun. 14, 2004).

Particular examples of heteroaromatic ligands including surface attachment groups (for forming a linking group to a substrate such as a cathode); include, but are not limited to:

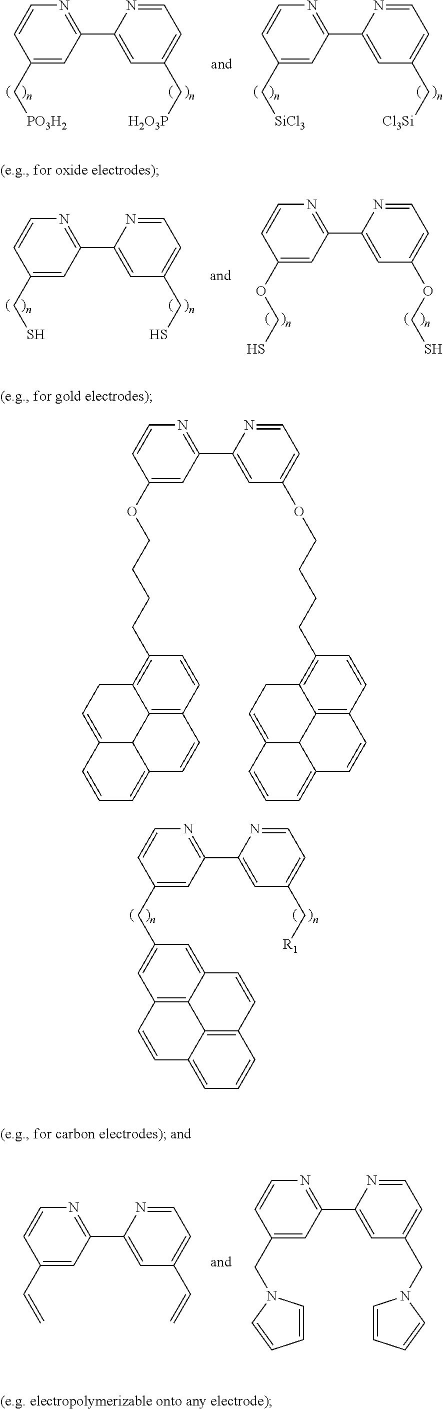

where each n is independently 1 or 2 to 4, 6, 8, or 10, or more, and R₁ is as given above.

3. Constructs.

Constructs such as cathode constructs of the present invention are produced by operatively associating a proton reduction catalyst as described above with a suitable body or substrate (in some preferred embodiments an electrode or cathode body comprised of a neutral material).

The particular composition and configuration of the construct body will depend upon the particular apparatus in which the construct is employed, as discussed in further detail below. In general, the substrate or electrode body may be formed of or comprise any suitable material, including rigid and flexible materials, transparent (e.g., to visible light) or opaque materials, organic or inorganic materials, conducting, semiconducting, and insulating materials, etc., including composites thereof. Particular examples of suitable materials include, but are not limited to, carbon (e.g., glassy carbon, grapheme, carbon nanotubes, reticulated vitreous carbon, boron-doped diamond, etc.), a transparent conducting oxide (e.g., indium-doped tino oxide (ITO), fluorine-doped tin oxide (FTO), etc.), metal (e.g., mercury, copper, gold, silver, platinum, etc.), and composites thereof.

The catalyst can be operatively associated with the substrate body or electrode by any suitable technique, including both covalent and non-covalent coupling (e.g., by surface polymerization), Numerous techniques are known (see, e.g., Y. Zhao and J. Stoddart, Accounts of Chemical Research 42, 1161-1171 (2009); A. LeGoff et al., Langmuir 29, 8736-8742 (2013)). The surface attachment group or groups described above can be chosen based upon the particular coupling reaction or scheme utilized. In addition, the catalyst can be operatively associated by providing the substrate body, electrode or cathode in combination with a freely diffusing catalyst (which may be originally coated on the substrate body or electrode for later diffusion in an electrolyte solution, or may be provided in an electrode solution).

4. Apparatus and Methods.

The methods and constructs described herein and above can be implemented in an apparatus or reactor assembly for generating oxygen and hydrogen from water, and particularly from an aqueous electrolyte solution (e.g., sea water), optionally modified as desired (e.g., by dilution, addition of other liquids, addition of other salts and buffers, etc.).

In general, and as noted above, an apparatus for the photoelectrocatalytic evolution of hydrogen and oxygen from water, comprises:

(a) a reactor vessel having (i) an oxygen generation chamber, (ii) a hydrogen generation chamber,

(b) a photohydride proton reduction catalyst operatively associated with said hydrogen generation chamber; wherein said photohydride proton reduction catalyst comprises a single-component light absorbing catalytic metal complex of the Formula AXB, wherein A is a coordinated aromatic group; X is a metal, and B is a heteroaromatic ligand;

(c) a photoanode in fluid communication with said oxygen generation chamber, said photoanode having a water oxidation catalyst operatively associated therewith;

(d) a light source operatively associated with said photohydride proton reduction catalyst and said photoanode (e.g., a window or transparent segment or segments, a fiber optic fiber, light pipe, photoelectric device, or combination thereof).

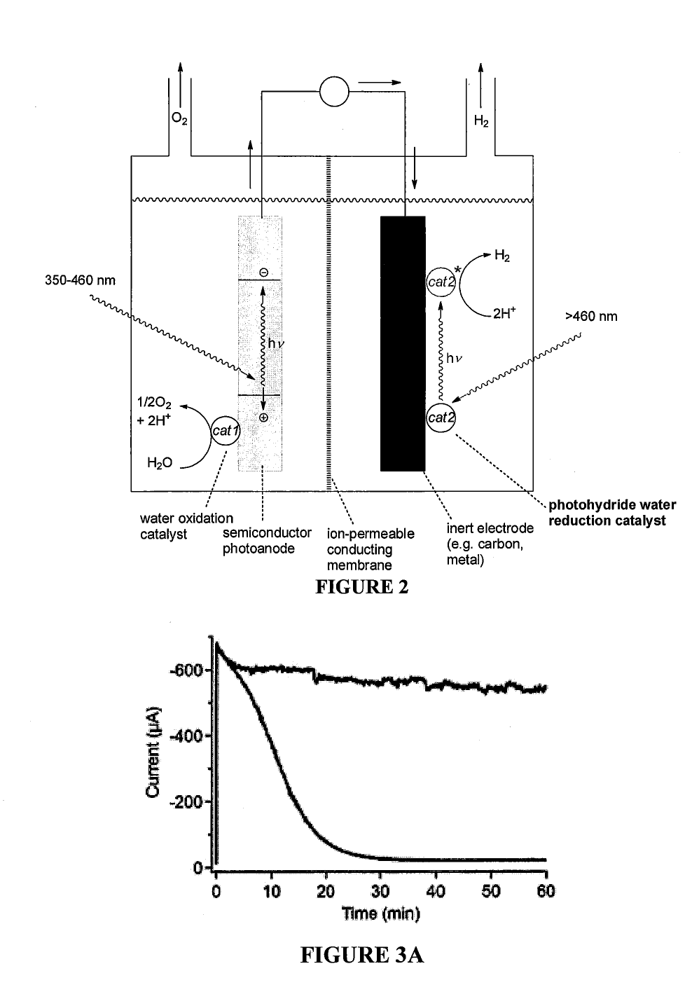

In the non-limiting example shown in FIG. 2, the apparatus further comprises an ion-permeable membrane (e.g., a fluoropolymer membrane such as a NAFION® membrane) separating the oxygen generation chamber and said hydrogen generation chamber. In this embodiment, the photoanode is positioned in the oxygen generation chamber, and in addition there is a cathode (and specifically, a neutral cathode) positioned in the hydrogen generation chamber. The photohydride proton reduction catalyst is operatively associated with said cathode (e.g., by covalent or non-covalent coupling as described above).

Numerous suitable photoanodes and associated water oxidation catalysts are known. Examples include, but are not limited to, those described in M. Walter et al, Chem. Rev. 110, 6446-6473 (2010) (numerous examples); S. Reece et al., Science 334, 645-648 (2011) (silicon photoanodes with Co phosphate catalysts); D. Zhong et al., J. Am. Chem. Soc. 133,: 18370-18377 (2011) (BiVO₄ photoanode with Co phosphate catalysts); D. Zhong et al: J. Am. Chem. Soc. 132, 4202-4207 (2010) (hematite (iron oxide) with Co phosphate catalysts); and R. Smith et al., Science 340, 60-63 (2013) (many different water oxidation catalysts).

The present invention is not limited to any specific apparatus architecture as numerous alternatives are available. For example, the invention could be embodied on a semiconductor substrate device such as described in D. Nocera, The Artificial Leaf, Accounts of Chemical Research 2011), or S. Reece et al., US Patent Application Pub. No. US 2011/0048962. In some of these embodiments, the apparatus further comprises a semiconductor substrate having an n-side and a p-side, with said p-side in fluid communication with said oxygen generation chamber; and said n-side in fluid communication with said hydrogen generation chamber; wherein: the water oxidation catalyst is operatively associated with the p-side, and the photohydride proton reduction catalyst is operatively associated with the n-side.

Electrolyte solutions. Any suitable electrolyte solution can be used to carry out the present invention, including but not limited to phosphate, citrate, acetate, borate, and chloride solutions (including sodium salts thereof). In some preliminary experiments electrolytes that did not workinclude sodium tetrafluoroborate, sodium perchlorate, sodium triflate, potassium chloride, sodium chloride, and sodium sulfate. For sodium chloride, this was solved by setting up the run on a smaller scale, apparently avoiding generating chlorine gas at the anode. The potassium chloride and sodium sulfate salts likely suffered from similar problems as was originally observed with sodium chloride. We think that changing the experimental setup will enhance the activity in those buffers as well. The tetrafluoroborate and perchlorate salts apparently did not work due to solubility problems in the particular embodiment, hence one of the catalytic species precipitated from solution. These electrolytes could be made to work by changing the catalyst identity such that the ligand is better able to solubilize the material, or by adding some organic solvent to the mixture to keep the same catalysts in solution, or by simply coupling the catalyst to a support such as an electrode or semiconductor as described herein. In general, different cell designs can help make a buffer or electrolyte work better. Also, if chlorine is being formed, the incorporation of a water oxidation catalyst (that does not generate any Cl₂) at the anode might alleviate the problems. Additional approaches may involve using different concentrations of salts, or using mixed electrolytes such as sodium chloride with a small amount of phosphate buffer.

Illumination can be carried out with any suitable light source as noted above, in some embodiments preferably with visible light such as sunlight (e.g., through a window or transparent segment of the vessel, through a light pipe, fiber optic, mirror or the like, etc. including combinations thereof). Artificial light sources such as LEDs may also be used if desired.

The vessel may be configured to operate in “batch” mode, such as schematically illustrated in FIG. 2, or may be configured to operate in continuous mode simply by adding a supply or reservoir for the electrolyte solution in fluid communication with the oxygen and hydrogen generation chambers.

In general, unless it is desired to comingle oxygen gas and hydrogen gas, the reactor vessel further comprises an oxygen vent in fluid communication with said oxygen generation chamber; and a hydrogen vent in fluid communication with said hydrogen generation chamber. Each can be associated with a suitable collection device such as a compressor, storage tank, etc.

The present invention is explained in greater detail in the following non-limiting Examples.

### EXPERIMENTAL

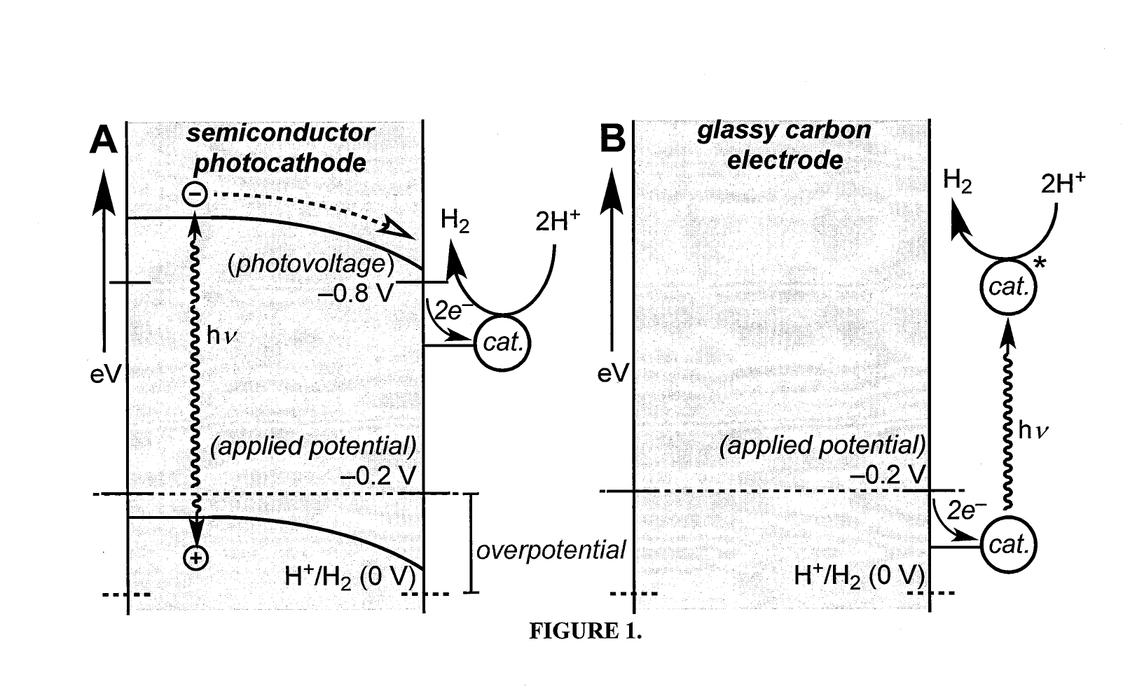

We hypothesized that an alternative PEC system could forgo a photocathode entirely, relying on a single molecular component that absorbs light and catalyzes the hydrogen evolution reaction. The approach is outlined in FIG. 1b.

A few molecules have been shown to photocatalytically produce hydrogen.⁸ Nocera has reported light-promoted H₂ release from a variety of strong acids in organic solvents. A particularly intriguing example comes from Ziessel, whose elegant studies on the photocatalytic water-gas shift reaction focused on [Cp*Ir(bpy)Cl]⁺ (1) and its derivatives. Irradiation of neutral aqueous solutions of 1 with a 250 W halogen lamp under CO pressure produced H₂. The hydride intermediate [Cp*Ir(bpy)H]⁺ (2) was proposed to be the key photoactive intermediate (Eq. 1).⁹ The nature of the excited state is still unclear, however: Fukuzumi reported that the excited state of 2 (2*) is strongly acidic,¹⁰ an apparent contradiction to Ziessel's observations.

We report herein the use of 1 as a homogenous photoelectrocatalyst. The resulting catalysis has features similar to semiconductor PEC systems: good activity is observed at very low overpotential in water under visible light irradiation.

The constituent steps of the cycle in FIG. 1b were investigated individually at first. Electrochemical studies of 1 in water are relatively limited in comparison to the Rh analogue (and despite extensive studies in acetonitrile solution). Cyclic voltammograms of 1 in pH 7 phosphate buffer (0.1 M) show an irreversible, poorly resolved 2e⁻ reduction around −0.74 V (data not shown). A quasi-reversible 1e⁻ reduction is observed at −1.25 V (not shown). This feature is assigned to the Ir^{III}—H⁺/Ir^{II}—H couple of hydride 2. Steckhan and coworkers previously inferred the formation of 2 based on the lack of return oxidation wave in CVs of 1, but to our knowledge direct electrochemical observation of the hydride has not been reported.¹¹ The ˜0.5 V separation between the redox couples of 1 and 2 is similar to the separation observed in acetonitrile solvent. Consistent with this assignment, the couple decreases as the solution pH increases, where Cp*Ir^{I}(bpy) is the dominant reduction product. At high pH (pH >10) a new oxidation feature is also observed around −0.25 V, assigned as a 2e⁻ oxidation of Cp*Ir(bpy).

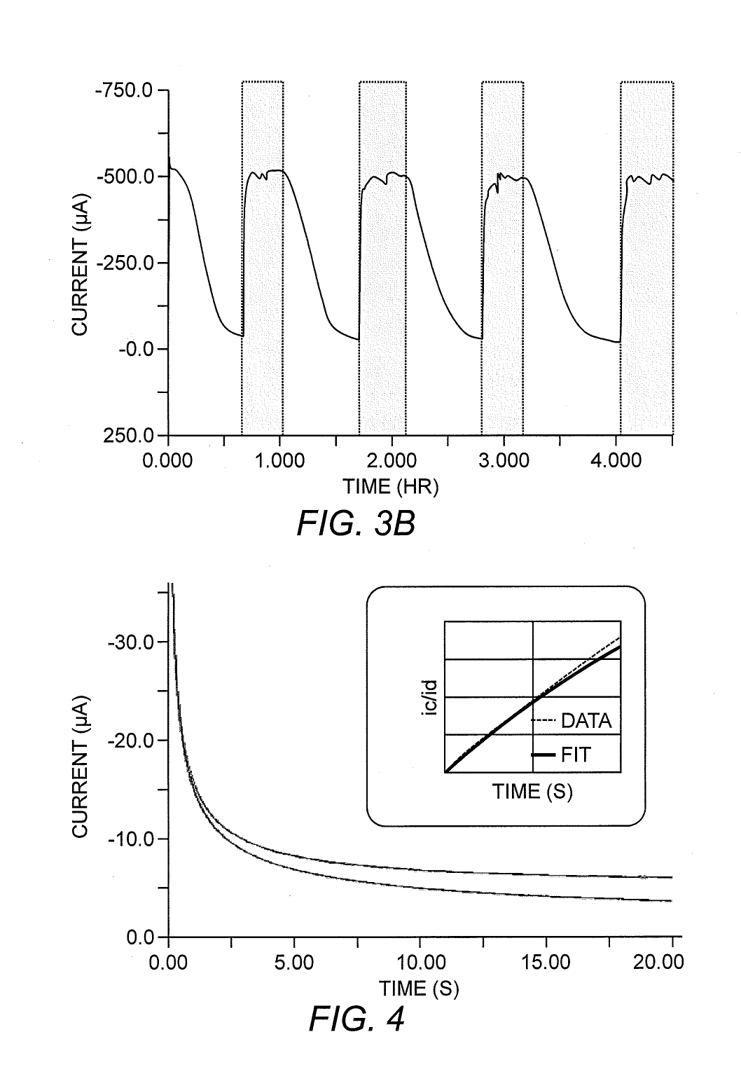

Controlled potential electrolysis of 1 in pH 7 phosphate buffer (potential held at −1 V NHE) protected from light confirmed the electrochemical production of hydride 2. Over 20 minutes at −1 V, current diminished to nearly zero. −433 C of total charge were passed, consistent with a 2e⁻ reduction of 1 (FIG. 3A). After electrolysis, the first reduction wave of 1 had essentially disappeared, while the hydride reduction remained (data not shown). The solution had also taken on a much brighter, golden hue. A prominent UV-vis absorption (λₘₐₓ=410 nm) indicated formation of 2.^{12,13}

Hydride 2 is stable in neutral phosphate buffer in the dark. Upon irradiation with a 460 nm LED lamp, however, hydride 2 is rapidly consumed with re-formation of 1, as judged by UVNis and CV. These observations parallel those of Ziessel, who also observed this once-stable complex rendered reactive by visible light. Controlled potential electrolysis once again produced golden 2, which was consumed upon photolysis, indicating that catalysis was feasible in a stepwise manner.

Sustained photoelectrocatalysis was targeted next. With the potential held at −1 V vs NHE (reticulated vitreous carbon working electrode), a 1 mM solution of 1 in pH 7 phosphate buffer was irradiated at 460 nm. Sustained photocurrent was observed over the course of the one-hour experiment (FIG. 3a). As described above, dark electrolysis passes similar current initially, but rapidly decays to nearly 0 as all of the chloride 1 in solution is converted to hydride 2. Without irradiation, 2 is not converted back to 1 and catalysis cannot occur. A roughly 25-fold increase in current is passed at −1 V upon irradiation. Bubbles were observed effervescing from solution and accumulating on the electrodes.

The influence of irradiation on the current is clearly shown in shutter experiments (FIG. 3b). In the dark, 2 builds up in solution as the passed current drops; in the light, the current quickly rises as photolysis of 2 produces 1 and initiates photoelectrocatalysis. Limiting dark current and light current are eventually attained. Unlike many semiconductor PECs, the current does not immediately fall to zero in the dark. Instead, decay over ˜20 min is observed as any 1 in solution is converted to 2. The slow decay of 1 upon shuttering implies that 1 is present in high concentration during catalysis.

The slow decay highlights a key difference in the two PEC arrangements: light absorption in the molecular system drives a chemical step whereas semiconductor PECs use light absorption to drive an electrochemical step. A catalytic cycle consistent with preliminary studies is shown in Scheme 1. In the first step, chloride 1 undergoes 2e⁻ reduction and protonation (at pH <10) to form hydride 2. Visible light absorption by hydride 2 produces excited state 2*, which reacts rapidly with a proton to release H₂ and re-forms 1. In the dark, hydride 2 builds up and no turnover is observed, consistent with light-promoted H₂ release. Each intermediate has been isolated or observed; as described above, the stepwise interconversion of 1 and 2 could also be observed. Nonetheless, various mechanistic subtleties surely remain. A full mechanistic study, probing the precise electrochemical and photochemical mechanisms and rates, is in progress.

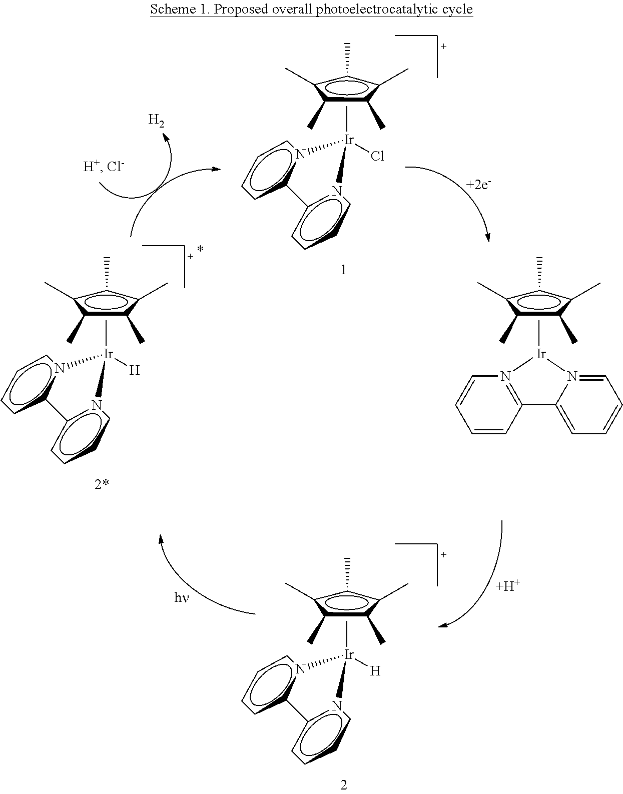

The evolved H₂ was detected by gas chromatography (GC). Quantification of Faradaic efficiency was carried out by headspace GC analysis after electrolysis and monitoring solution pH change during electrolysis. As H₂ is produced, protons are consumed, leading to an increase in pH during electrolysis. The measured pH increase can be related to the pH increase expected if each electron produced 0.5 equiv H₂ to obtain a measure of Faradaic efficiency.¹⁴ A weakly buffered solution (50 mM phosphate, initial pH 7.8) was held at −0.9 V and irradiated, and the pH measured periodically. The pH increased as expected, with Faradaic efficiency ˜100% at early times, falling slightly to ˜90% as the experiment proceeded and the pH rose (data not shown). The results of the GC headspace analysis are consistent with the pH time course, and confirm that H₂ is the product of proton consumption in at least 70% Faradaic efficiency.

Based on the Faradaic efficiency, the current passed in a typical one-hour experiment produced more than one turnover of H₂. Turnover numbers for molecular catalysts are often underestimated in controlled potential electrolysis cells because very little of the catalyst is near the electrode at any given time. The experiment does confirm that 1 is a stable catalyst for a continuous PEC cycle sustained solely by a homogenous catalyst.

Cyclic voltammetry is often used to measure catalytic rate constants that are more meaningful than those obtained from bulk experiments.² To probe for evidence of photoelectrocatalysis, CV was performed on phosphate solutions of 1 in the light and the dark at scan rates between 5 and 500 mV·s⁻¹. Some evidence for catalysis was observed, but only at very slow scan rates (<25 mV·s⁻¹, data not shown). While consistent with slow photoelectrocatalysis, quantitative interpretation of catalytic behavior is not possible because such slow scan rates can lead to convolution from convection.²

Chronoamperompetry (CA) proved a suitable technique for measuring rate constants. Delahay and Stiehl showed that division of the current passed under catalytic conditions by the current passed under diffusive conditions could be fit to give an apparent rate constant for an EC′ mechanism.¹⁵ The standard phosphate buffer conditions described above were studied in a similar cell but with a glassy carbon working electrode and no stirring. Potentials between −0.5 and −1.1 V were applied for 20 seconds in the dark and under 460 nm LED irradiation. Irradiated samples passed significantly more current that those protected from light (FIG. 4). The ratio of the dark and light traces and a least-squares fit of the data between 5 and 10 seconds gave k_{obs}=0.037 s⁻¹ at −0.8 V. The mathematical treatment assumes that electron transfer is fast, such that the observed rate constant is a reflection of a chemical step. The observed rate constant can therefore be considered identical to the catalyst turnover frequency (TOF).

The onset of photocatalytic current was observed at roughly −0.55 V at pH 7, an overpotential (to achieve k_{obs}=0.011 s⁻¹) for hydrogen evolution of only 150 mV (data not shown). This early onset potential is surprising not only for the low overpotential, but because the potential is held well positive of the broad initial reduction feature. This could be an indication that disproportionation is an important mechanistic feature, as has been previously suggested. In this case, a 1e⁻ reduction would form an Ir^{II} species that reacts with itself to form Ir^{III} and Ir^{I}, the latter of which is protonated to form hydride 2. As the applied potential is held more negative, the rate of catalysis increases, reaching a maximum at −0.8 V and remaining roughly level out to −1 V (data not shown).

The observed rate constants obtained from chronoamperometry did not follow the expected trend based on electron donating ability of the various ligands. The most electron rich catalyst [Cp*Ir(bpy-OMe)(Cl)][Cl] (1-OMe₂, bpy-X=4,4′-X-2,2′-bipyridine, X=OMe, COOH) gave k_{obs}=0.090(5) s⁻¹ at −1 V. Under the experimental conditions (pH 7), the catalyst [Cp*Ir(bpy-COOH)(Cl)][Cl] (1-COOH₂) is almost certainly deprotonated, which would lead to an electron donating ability intermediate between 1 and 1-OMe₂. However, 1-COOH₂ outperformed both catalysts, with k_{obs}=0.20(1) s⁻¹ at −0.8 V. Carboxylate-substituted catalyst 1-COOH₂ also operates at lower overpotentials than 1 (k_{obs}=0.034(28) s⁻¹ at zero overpotential) , and CV traces show the onset of catalysis occurs just prior to the thermodynamically required potential for H₂ evolution. This situation is only possible when photon energy is being utilized.

In summary, a novel system for photoelectrocatalytic H₂ evolution has been described that relies on a single molecular component that acts as catalyst and chromophore. Light-promoted H₂ evolution is observed from buffered water over a wide pH range using three different Ir catalysts.

### REFERENCES

(1) Cook, T. R.; Dogutan, D. K.; Reece, S. Y.; Surendranath, Y.; Teets, T. S.; Nocera, D. G. Chem. Rev. 2010, 110, 6474-502.

(2) Dempsey, J. L. Dempsey- H2 Echem-Draft v12 2013.

(3) Wilson, A. D.; Newell, R. H.; McNevin, M. J.; Muckerman, J. T.; Rakowski DuBois, M.; DuBois, D. L. J Am. Chem. Soc. 2006, 128, 358-66.

(4) Sun, Y.; Bigi, J. P.; Piro, N. a; Tang, M. L.; Long, J. R.; Chang, C. J. J. Am. Chem. Soc. 2011, 133, 9212-5.

(5) Sun, Y.; Sun, J.; Long, J. R.; Yang, P.; Chang, C. J. Chem. Sci. 2013, 4, 118.

(6) Alibabaei, L.; Luo, H.; House, R. L.; Hoertz, P. G.; Lopez, R.; Meyer, T. J. J. Mat.

Chem. A 2013, 1, 4133.

(7) Lewerenz, H. J.; Heine, C.; Skorupska, K.; Szabo, N.; Hannappel, T.; Vo-Dinh, T.; Campbell, S. a.; Klemm, H. W.; Muñoz, a. G. Energy & Environmental Science 2010, 3, 748.

(8) Esswein, A. J.; Nocera, D. G. Chem. Rev. 2007, 107, 4022-47.

(9) Ziessel, R. J. Am. Chem. Soc. 1993, 118-127.

(10) Suenobu, T.; Guldi, D. M.; Ogo, S.; Fukuzumi, S. Angewandte Chemie (International ed. in English) 2003, 42, 5492-5.

(11) Steckhan, E.; Herrmann, S.; Ruppert, R.; Dietz, E.; Frede, M.; Spika, E. Organometallics 1991, 1568-1577.

(12) Ladwig, M.; Kaim, W. J. Organomet. Chem. 1992, 439, 79-90.

(13) Youinou, M.-T.; Ziessel, R. J Organomet. Chem 1989, 363, 197.

(14) Karunadasa, H. I.; Montalvo, E.; Sun, Y.; Majda, M.; Long, J. R.; Chang, C. J. Science 2012, 335, 698-702.

(15) Delahay, P.; Stiehl, G. L. J. Am. Chem. Soc. 1952, 74, 3500.

The foregoing is illustrative of the present invention, and is not to be construed as limiting thereof. The invention is defined by the following claims, with equivalents of the claims to be included therein.

That which is claimed is:

1. A method for the photoelectrocatalytic production of hydrogen and oxygen from water, comprising:
(a) providing a photohydride proton reduction catalyst and a photoanode having water oxidation catalyst operatively associated therewith, both in an aquous electrolyte solution,
wherein said photohydride proton reduction catalyst comprises a single-component light absorbing catalytic metal complex of the formula AXB, wherein A is a coordinated aromatic group, X is a metal, and B is a bidentate organic ligand; and
(b) illuminating said photoanode and said photohydride proton reduction catalyst with visible light to generate 0₂ by the action of said water oxidation catalyst and H₂ by the action of said photohydride proton reduction catalyst.

2. The method of claim 1, wherein said photohydride proton reduction catalyst is operatively associated with a cathode.

3. The method of claim 2, wherein said cathode and said anode are electrically connected by both an external circuit and said electrolyte solution.

4. The method of claim 1, wherein said both said water oxidation catalyst and said photohydride proton reduction catalyst are operatively associated with a semiconductor substrate.

5. The method of claim 4, said semiconductor substrate having an n-side and a p-side, wherein said water oxidation catalyst is operatively associated with said p-side, and said photohydride proton reduction catalyst is operatively associated with said n-side.

6. The method of claim 1, wherein A is a 5 to 7 carbon aromatic ring or fused ring system, optionally substituted from 1 to 7 times with independently selected electron withdrawing groups, electron donating groups, surface attachment groups or linking groups formed from the coupling of said surface attachment group to said cathode.

7. The method of claim 1, wherein A is selected from the group consisting of: 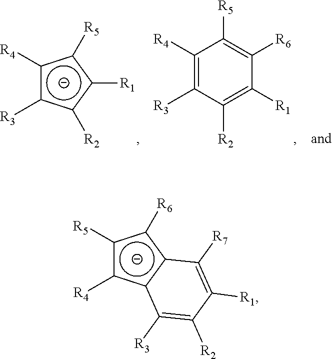
wherein each of R₁, R₂, R₃, R₄, R₅, R₆, and R₇ when present is independently selected from the group consisting of H, electron withdrawing groups, electron donating groups, surface attachment groups and linking groups formed from the coupling of said surface attachment group to a substrate, electrode or cathode.

8. The method of claim 1, wherein X is iridium, rhodium, or cobalt.

9. The method of claim 1, wherein B comprises a bidendate organic group containing from 1 to 4 nitrogen atoms and 6 to 20 carbon atoms, which organic group is optionally substituted from 1 to 20 times with independently selected electron withdrawing groups, electron donating groups, surface attachment groups, and linking groups formed from the coupling of said surface attachment groups to said cathode.

10. The method of claim 1, wherein B is selected from the group consisting of: 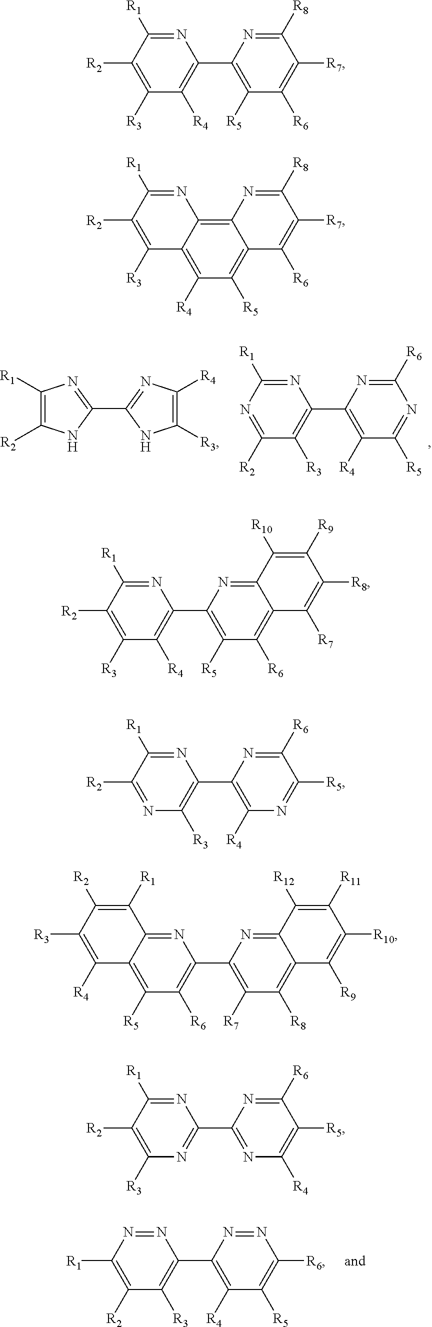 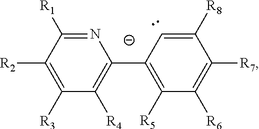
wherein each of R₁, R₂, R₃, R₄, R₅, R₆, R₇, R₈, R₉, R₁₀, R₁₁ and R₁₂ when present is independently selected from the group consisting of H, electron withdrawing groups, electron donating groups, surface attachment groups, and linking groups formed from the coupling of said surface attachment groups to a substrate, electrode or cathode.

11. The method of claim 1, wherein said photohydride photon reduction catalyst is a compound of the Formula: 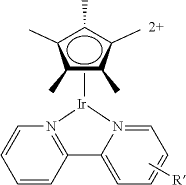
or a salt thereof, wherein R′ is a linking group to said electrode.

12. The method of claim 1, wherein said aqueous electrolyte solution comprises a phosphate, citrate, acetate, or borate salt.

13. The method of claim 1, wherein said cathode comprises carbon, a transparent conducting oxide, metal, or a composite thereof.

14. A construct useful for the photoelectrocatalytic evolution of hydrogen from water, comprising:
(a) an electrode body; and
(b) a photohydride proton reduction catalyst operatively associated with said electrode body;
wherein said photohydride proton reduction catalyst comprises a single-component light absorbing catalytic metal complex of the Formula AXB, wherein A is a coordinated aromatic group; X is a metal, and B is a bidentate organic ligand.

15. The construct of claim 14, wherein said electrode body comprises carbon.

16. The construct of claim 14, wherein said electrode body comprises a semiconductor substrate.

17. The construct of claim 14, further comprising a water oxidation catalyst operatively associated with said electrode body.

18. The construct of of claim 16, said semiconductor substrate having an n-side and a p-side, wherein said water oxidation catalyst is operatively associated with said p-side, and said photohydride proton reduction catalyst is operatively associated with said n-side.

19. The construct of claim 14, wherein A is a 5 to 7 carbon aromatic ring or fused ring system, optionally substituted from 1 to 7 times with independently selected electron withdrawing groups, electron donating groups, surface attachment groups or linking groups formed from the coupling of said surface attachment group to said cathode.

20. The construct of claim 14, wherein A is selected from the group consisting of: 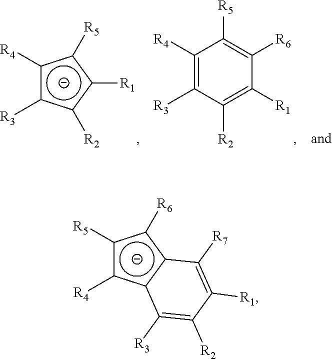
wherein each of R₁, R₂, R₃, R₄, R₅, R₆, and R₇ when present is independently selected from the group consisting of H, electron withdrawing groups, electron donating groups, surface attachment groups and linking groups formed from the coupling of said surface attachment group to a substrate, electrode or cathode.

21. The construct of claim 14, wherein X is iridium, rhodium, or cobalt.

22. The construct of claim 14, wherein B comprises a bidendate organic group containing from 1 to 4 nitrogen atoms and 6 to 20 carbon atoms, which organic group is optionally substituted from 1 to 20 times with independently selected electron withdrawing groups, electron donating groups, surface attachment groups, and linking groups formed from the coupling of said surface attachment groups to said cathode.

23. The construct of claim 14, wherein B is selected from the group consisting of: 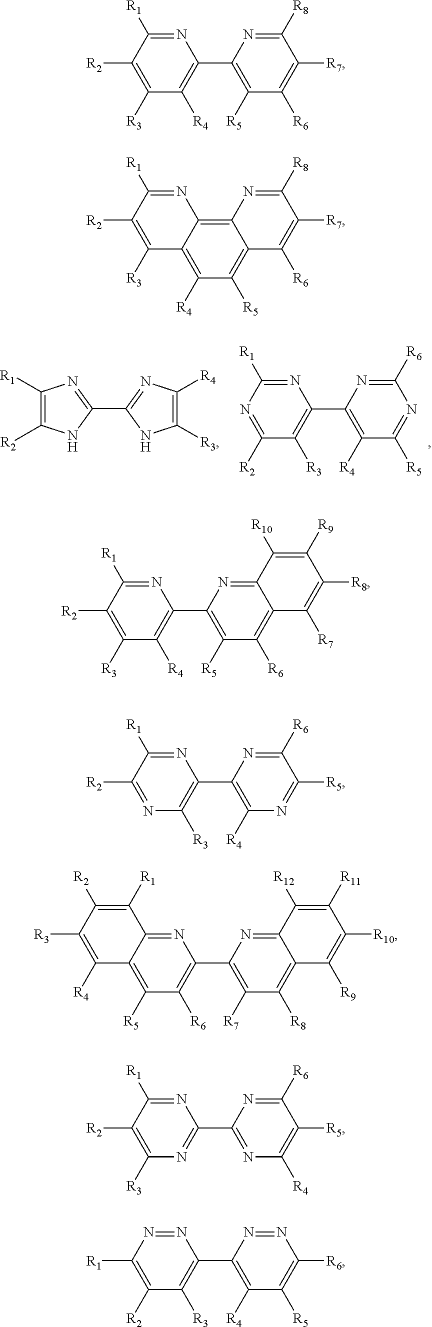 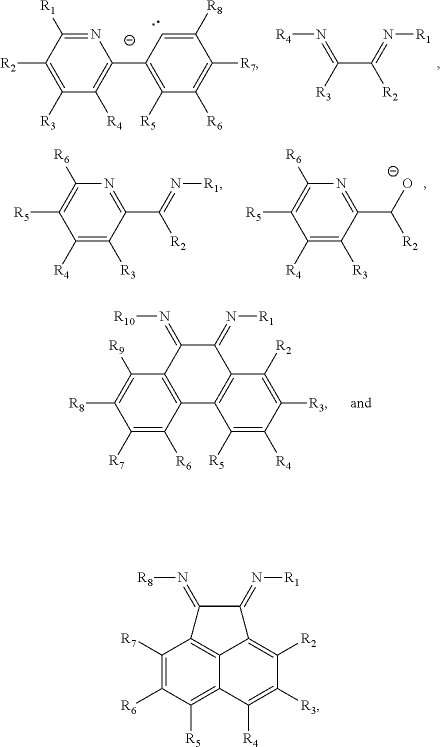
wherein each of R₁, R₂, R₃, R₄, R₅, R₆, R₇, R₈, R₉, R₁₀, R₁₁ and R₁₂ when present is independently selected from the group consisting of H, electron withdrawing groups, electron donating groups, surface attachment groups, and linking groups formed from the coupling of said surface attachment groups to a substrate, electrode or cathode.

24. An apparatus for the photoelectrocatalytic evolution of hydrogen and oxygen from water, comprising:
(a) a reactor vessel having (i) an oxygen generation chamber, (ii) a hydrogen generation chamber,
(b) a photohydride proton reduction catalyst operatively associated with said hydrogen generation chamber; wherein said photohydride proton reduction catalyst comprises a single-component light absorbing catalytic metal complex of the Formula AXB, wherein A is a coordinated aromatic group; X is a metal, and B is a bidentate organic ligand;
(c) a photoanode in fluid communication with said oxygen generation chamber, said photoanode having a water oxidation catalyst operatively associated therewith;
(d) a light source operatively associated with said photohydride proton reduction catalyst and said photoanode.

25. The apparatus of claim 24, further comprising an ion-permeable membrane separating said oxygen generation chamber and said hydrogen generation chamber.

26. The apparatus of claim 24, further comprising a cathode in fluid communication with said hydrogen generation chamber, wherein said photohydride proton reduction catalyst is operatively associated with said cathode.

27. The apparatus of claim 24, further comprising a semiconductor substrate having an n-side and a p-side, with
said p-side in fluid communication with said oxygen generation chamber; and
said n-side in fluid communication with said hydrogen generation chamber;
wherein:
said water oxidation catalyst is operatively associated with said p-side, and
said photohydride proton reduction catalyst is operatively associated with said n-side.

28. The apparatus of claim 24, wherein said reactor vessel further comprises:
(e) an oxygen vent in fluid communication with said oxygen generation chamber; and
(f) a hydrogen vent in fluid communication with said hydrogen generation chamber.

29. The apparatus of claim 24, wherein said light source comprises a window, fiber optic fiber, light pipe, photoelectric device, or combination thereof.

30. The apparatus of claim 24, wherein A is a 5 to 7 carbon aromatic ring or fused ring system, optionally substituted from 1 to 7 times with independently selected electron withdrawing groups, electron donating groups, surface attachment groups or linking groups formed from the coupling of said surface attachment group to said cathode.

31. The apparatus of claim 24, wherein A is selected from the group consisting of: 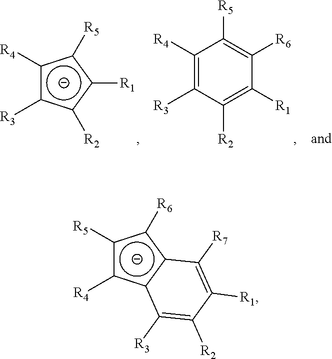
wherein each of R₁, R₂, R₃, R₄, R₅, R₆, and R₇ when present is independently selected from the group consisting of H, electron withdrawing groups, electron donating groups, surface attachment groups and linking groups formed from the coupling of said surface attachment group to a substrate, electrode or cathode.

32. The apparatus of claim 24, wherein X is iridium, rhodium, or cobalt.

33. The apparatus of claim 24, wherein B comprises a bidendate organic group containing from 1 to 4 nitrogen atoms and 6 to 20 carbon atoms, which organic group is optionally substituted from 1 to 20 times with independently selected electron withdrawing groups, electron donating groups, surface attachment groups, and linking groups formed from the coupling of said surface attachment groups to said cathode.

34. The apparatus of claim 24, wherein B is selected from the group consisting of: 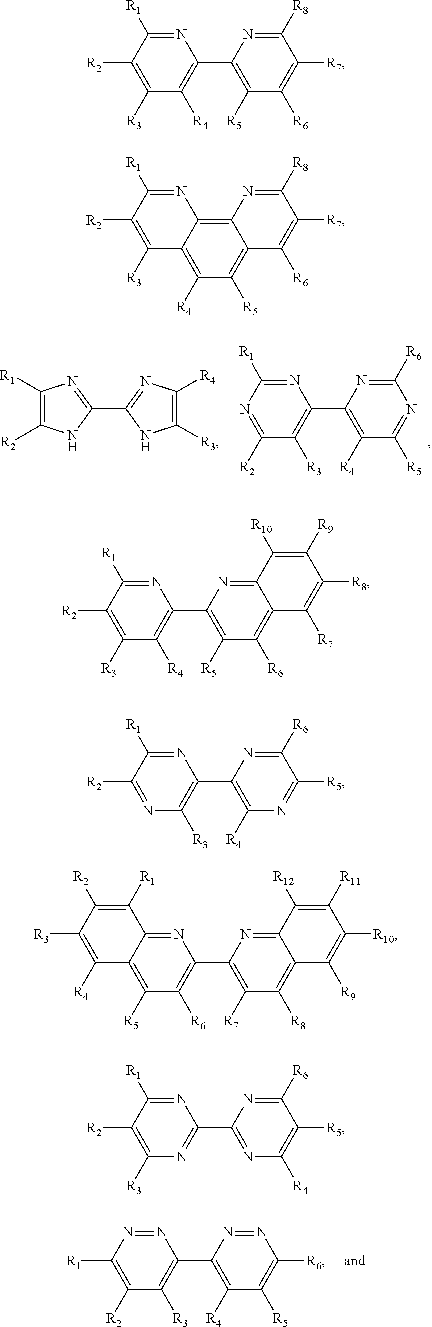 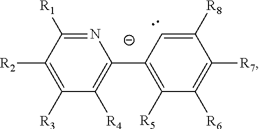
wherein each of R₁, R₂, R₃, R₄, R₅, R₆, R₇, R₈, R₉, R₁₀, R₁₁ and R₁₂ when present is independently selected from the group consisting of H, electron withdrawing groups, electron donating groups, surface attachment groups, and linking groups formed from the coupling of said surface attachment groups to a substrate, electrode or cathode.
